(19) United States
(12) Patent Application Publication
(10) Pub. No.: US 2025/0231084 A1
(43) Pub. Date: Jul. 17, 2025

(54) OPTICAL FIBER MONITORING SYSTEM, REMOTE MONITORING DEVICE, AND OPTICAL FIBER MONITORING METHOD

(71) Applicant: NEC Corporation, Tokyo (JP)

(72) Inventor: Misa FUNAHASHI, Tokyo (JP)

(73) Assignee: NEC Corporation, Tokyo (JP)

(21) Appl. No.: 18/976,737

(22) Filed: Dec. 11, 2024

(30) Foreign Application Priority Data
Jan. 12, 2024 (JP) 2024-003456

(51) Int. Cl. G01M 11/00

(52) U.S. Cl. CPC G01M 11/31

(57) ABSTRACT

An optical fiber monitoring system includes an optical fiber including a plurality of cores, in which a pair of cores are designated as a core pair from among the plurality of cores, and to which a plurality of the core pairs are allocated, and a remote monitoring device that acquires a monitoring result indicating a state of the optical fiber by use of monitoring light for each of the core pairs, wherein the remote monitoring device acquires, according to a first monitoring result being the monitoring result of a first core pair included in the plurality of core pairs, a second monitoring result indicating a state of a second core pair being another core pair.

This application is based upon and claims the benefit of priority from Japanese patent application No. 2024-003456, filed on Jan. 12, 2024, the disclosure of which is incorporated herein in its entirety by reference.

### TECHNICAL FIELD

The present disclosure relates to an optical fiber monitoring system and the like.

### BACKGROUND ART

In a transmission system (hereinafter, referred to as an “optical transmission system”) using an optical fiber, one optical cable may accommodate a plurality of optical fibers, and a set of optical fibers to be a pair may be allocated as a fiber pair (FP), for a purpose of efficiently accommodating a rapidly increasing traffic demand. Moreover, in recent years, there has also appeared an optical transmission system adopting a multi-core fiber (MCF) including a plurality of cores in one optical fiber. In such an optical transmission system, a set of cores to be a pair may be allocated as a core pair (CP). Moreover, in the optical transmission system, an optical repeater including an optical fiber amplifier is often arranged in a middle of an optical cable. A remote monitoring device for monitoring a state of such an FP or a CP is known. The remote monitoring device is installed at a terminal station of an optical transmission system, and monitors a state of one FP or one CP by one measurement.

In relation to the present disclosure, patent literature 1 (PTL1, Japanese Unexamined Patent Application Publication No. 2014-165595) describes a technique related to an optical switching device to be used in an optical transmission system using an MCF.

### SUMMARY

As a remote monitoring device of an optical fiber transmission path, an optical time domain reflectometer (OTDR) is known. In order to reduce the remote monitoring device in size, some remote monitoring devices have a function of switching an FP or a CP to be connected, and monitoring the FP and the CP one by one in order. Meanwhile, due to an increase in traffic capacity to be accommodated in an optical transmission system, about several tens of FPs and CPs may be accommodated within one optical cable. In such an optical transmission system, there is a concern that extremely much time is required in order to monitor states of all FPs and CPs with a monitoring method of an FP and a CP using one remote monitoring device.

An object of the present disclosure is to provide a technique for shortening time required for monitoring a core pair within an optical cable.

### Solution to Problem

An optical fiber monitoring system according to the present disclosure includes: an optical fiber including a plurality of cores, in which a pair of cores are designated as a core pair from among the plurality of cores, and to which a plurality of the core pairs are allocated; and a remote monitoring device that acquires a monitoring result indicating a state of the optical fiber by use of monitoring light for each of the core pairs, wherein the remote monitoring device acquires, according to a first monitoring result being the monitoring result of a first core pair included in the plurality of core pairs, a second monitoring result indicating a state of a second core pair being another core pair.

A remote monitoring device according to the present disclosure includes: a first acquisition means for acquiring a monitoring result indicating a state of an optical fiber including a plurality of cores, in which a pair of cores are designated as a core pair from among the plurality of cores, and to which a plurality of the core pairs are allocated, by use of monitoring light for each of the core pairs; and a second acquisition means for acquiring, according to a first monitoring result being the monitoring result of a first core pair included in the plurality of core pairs, a second monitoring result indicating a state of a second core pair being another core pair.

An optical fiber monitoring method according to the present disclosure includes: a procedure of acquiring a monitoring result indicating a state of an optical fiber including a plurality of cores, in which a pair of cores are designated as a core pair from among the plurality of cores, and to which a plurality of the core pairs are allocated, by use of monitoring light for each of the core pairs; and a procedure of acquiring, according to a first monitoring result being the monitoring result of a first core pair included in the plurality of core pairs, a second monitoring result indicating a state of a second core pair being another core pair.

The present disclosure provides a technique for shortening time required for monitoring a core pair within an optical cable.

### BRIEF DESCRIPTION OF THE DRAWINGS

Exemplary features and advantages of the present invention will become apparent from the following detailed description when taken with the accompanying drawings in which:

FIG. 1 is an exemplary diagram illustrating a configuration example of an optical fiber monitoring system;

FIG. 2 is an exemplary diagram describing monitoring of a 2-core MCF;

FIG. 3 is an exemplary diagram describing an example of monitoring of a 4-core MCF;

FIG. 4 is an exemplary diagram illustrating an example of a cross-section of an optical fiber;

FIG. 5 is an exemplary diagram illustrating a configuration example of the optical fiber monitoring system;

FIG. 6 is an exemplary diagram illustrating an example of a cross-section of the optical fiber;

FIG. 7 is an exemplary diagram illustrating a configuration example of an optical repeater;

FIG. 8 is an exemplary diagram describing an example of an order of monitoring an optical fiber;

FIG. 9 is an exemplary diagram describing an example of an order of monitoring an optical fiber;

FIG. 10 is an exemplary diagram illustrating an example of occurrence of a breaking failure;

FIG. 11 is an exemplary diagram illustrating an example of a monitoring procedure after occurrence of the breaking failure;

FIG. 12 is an exemplary diagram illustrating another example of a monitoring procedure after occurrence of the breaking failure;

FIG. 13 is an exemplary diagram illustrating occurrence of an LD failure;

FIG. 14 is an exemplary diagram illustrating an example of a configuration in which excitation LD is shared;

FIG. 15 is an exemplary diagram illustrating an example of a monitoring procedure after occurrence of an LD failure;

FIG. 16 is an exemplary diagram illustrating another example of a monitoring procedure after occurrence of the LD failure; and

FIG. 17 is an exemplary flowchart illustrating an example of an optical fiber monitoring method.

### EXAMPLE EMBODIMENT

Example embodiments according to the present disclosure are described below with reference to the drawings. The same reference signs are given to an already mentioned element in the example embodiments and the drawings, and repeated description may be omitted.

### First Example Embodiment

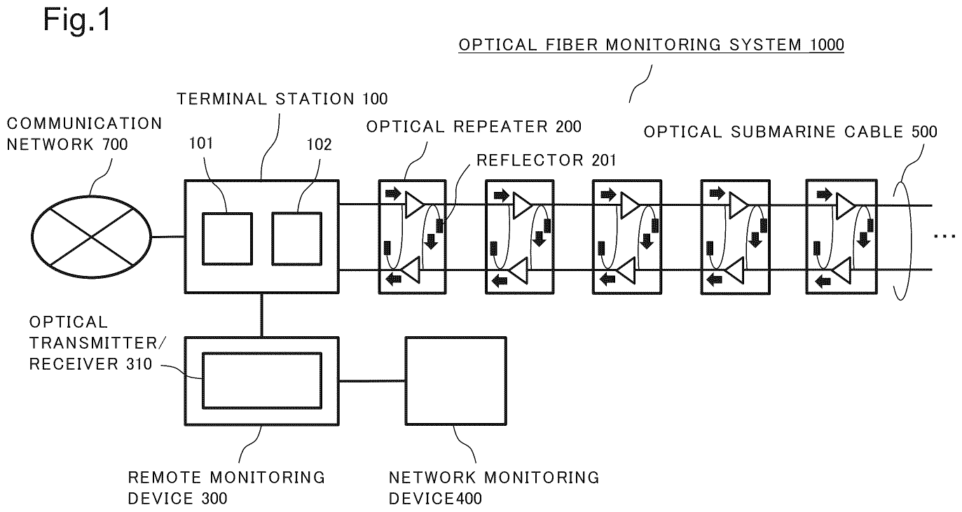

FIG. 1 is a diagram illustrating a configuration example of an optical fiber monitoring system 1000 according to the present disclosure. The optical fiber monitoring system 1000 includes a terminal station 100, an optical repeater 200, a remote monitoring device 300, a network monitoring device 400, and an optical submarine cable 500.

The terminal station 100 is a land station installed on land, and has an interface function between the optical submarine cable 500 and a communication network 700 on land. The terminal station 100 includes an optical interface 101 and an optical multiplexer/demultiplexer (optical MUX/DEMUX) 102. The optical interface 101 transmits and receives signal light to and from the optical submarine cable 500. The optical multiplexer/demultiplexer 102 is arranged between the optical interface 101 and the optical submarine cable 500, and multiplexes and demultiplexes monitoring light and signal light. The optical multiplexer/demultiplexer 102 couples signal light between the optical submarine cable 500 and the optical interface 101, and couples monitoring light and reflected light between the optical submarine cable 500 and the remote monitoring device 300.

The optical repeater 200 is arranged in a middle of the optical submarine cable 500. The optical repeater 200 amplifies each piece of input bi-directional light, and multiplexes reflected light and light in an opposite direction. The reflected light is light acquired by turning back a part of monitoring light. The reflected light propagates in a direction (uplink direction) opposite to monitoring light sent in a direction (downlink direction) of the optical repeater 200 from the terminal station 100. For turning back of monitoring light, for example, a reflector 201 included in each of the optical repeaters 200 is used. Note that, since a general configuration for turning back monitoring light in the optical repeater 200 is known, detailed description is omitted. The terminal station 100 receives signal light in the uplink direction and reflected light multiplexed with the signal light.

The remote monitoring device 300 includes an optical transmitter/receiver 310. The optical transmitter/receiver 310 transmits monitoring light to the terminal station 100, and receives reflected light (return light) of the monitoring light from the terminal station 100, by control from the network monitoring device 400. The optical transmitter/receiver 310 transmits monitoring light to one core of a selected core pair, and receives return light of the monitoring light from another core of the selected core pair. The network monitoring device 400 selects a core of the optical submarine cable 500 to be a target of monitoring, and instructs the remote monitoring device 300 to send the monitoring light to the selected core. A wavelength of the monitoring light may be a specific wavelength different from that of signal light. The remote monitoring device 300 monitors reflected light turned back in each of the optical repeaters 200, and acquires a state of the optical submarine cable 500 by use of a result of the monitoring. When acquisition of a monitoring result ends, the remote monitoring device 300 transmits, to the network monitoring device 400, the monitoring result including information of a failure point of the optical submarine cable 500, and a monitoring completion notification. A monitoring result is, for example, information of at least one of presence or absence of abnormality such as breaking of a path through which monitoring light and return light propagate, and a loss, but is not limited thereto.

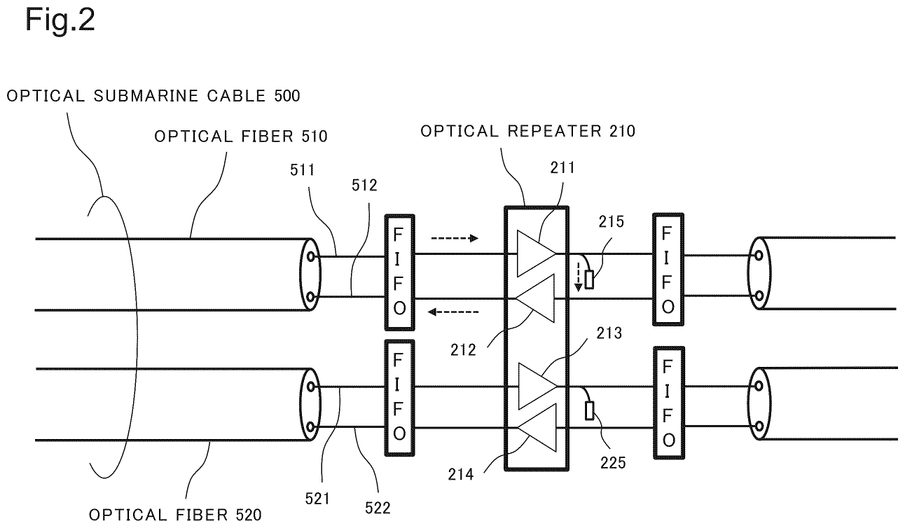

FIG. 2 is a diagram describing monitoring of two 2-core MCFs in the optical fiber monitoring system 1000. The optical submarine cable 500 includes optical fibers 510 and 520. Each of the optical fibers 510 and 520 includes one CP. Then, a core 511 of the optical fiber 510 transmits downlink light, and a core 512 transmits uplink light. The same also applies to the optical fiber 520. An optical repeater 210 includes four optical amplifiers 211 to 214, and amplifies light propagating a core of each of the optical fibers 510 and 520. The optical fibers 510 and 520 and the optical repeater 210 may be connected to each other by a fan-in/fan-out (FIFO). Moreover, the optical repeater 210 includes reflectors 215 and 225. Monitoring light propagating through the core 511 in a downlink direction is turned back by the reflector 215, and propagates through the core 512 in an uplink direction as reflected light. Similarly, monitoring light propagating through the core 521 in a downlink direction is turned back by the reflector 225, and propagates through the core 522 in an uplink direction as reflected light.

The network monitoring device 400 first selects the optical fiber 510 as a monitoring target. The remote monitoring device 300 first sends monitoring light to the core 511 of the optical fiber 510. The monitoring light is sent to the core 511 via the terminal station 100. The monitoring light that has propagated through the core 511 is turned back by the reflector 215, and received in the remote monitoring device 300 via the core 512 and the terminal station 100. When processing relating to a state of the optical fiber 510 ends, and a measurement result of the optical fiber 510 is normal, the remote monitoring device 300 sends the monitoring light to the core 521 of the optical fiber 520, and monitors a state of the optical fiber 520 in a procedure similar to that for the optical fiber 510.

The above procedure sends monitoring light to one CP included in the one optical fiber 510, and, after end of monitoring of the one CP, shifts to measurement of another one of the optical fibers 520.

### Modified Example of First Example Embodiment

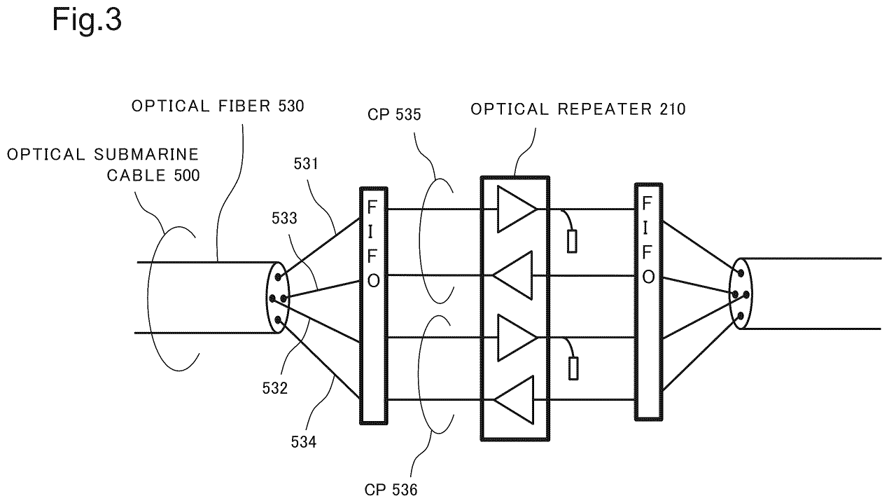

FIG. 3 is a diagram describing an example of monitoring of a 4-core MCF in the optical fiber monitoring system 1000. The optical submarine cable 500 includes an optical fiber 530. The optical fiber 530 is a 4-core MCF including four cores 531 to 534. The cores 531 and 533 constitute a core pair (CP) 535, and the cores 532 and 534 constitute a CP 536. The cores 531 and 532 transmit downlink light, and the cores 533 and 534 transmit uplink light.

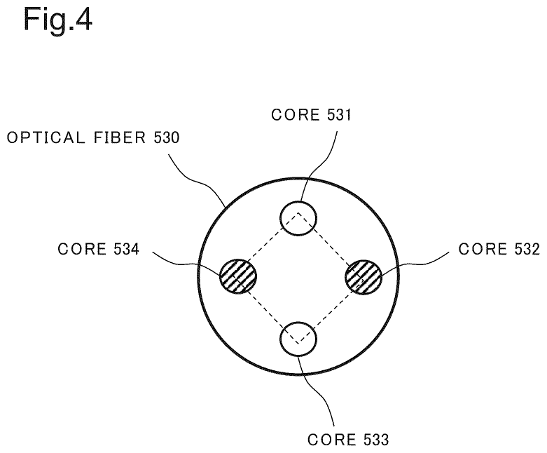

FIG. 4 is a diagram illustrating an example of a cross-section of the optical fiber 530. The cores 531 to 534 are arranged in such a way that positions thereof become four vertices of one square. In FIG. 4, the cores 531 to 534 are arranged in this order at positions going around clockwise vertices of a square indicated by a broken line.

In a configuration of FIG. 3, the optical repeater 210 includes the four optical amplifiers 211 to 214. The optical amplifiers 211 to 214 each amplify light propagating through a core of each of the cores 531 to 534. Monitoring light propagating through the core 531 in a downlink direction is turned back by the reflector 215, and propagates through the core 533 in an uplink direction as reflected light. Similarly, monitoring light propagating through the core 532 in a downlink direction is turned back by the reflector 225, and propagates through the core 534 in an uplink direction as reflected light.

When the configuration of FIG. 3 is applied to the optical fiber monitoring system 1000, the network monitoring device 400 first selects the CP 535 as a monitoring target. Then, the remote monitoring device 300 sends monitoring light to the core 531 of the CP 535. The monitoring light is sent to the core 531 via a terminal station 100. The monitoring light that has propagated through the core 531 is turned back by the reflector 215, and received in a remote monitoring device 300 via the core 533 and the terminal station 100. When monitoring of the CP 535 ends, and a monitoring result of the CP 535 is normal, the remote monitoring device 300 ends monitoring of the optical fiber 530, and, when there is another optical fiber, the remote monitoring device 300 starts monitoring of the optical fiber. In other words, in a procedure according to the present modified example, initially, monitoring light is sent to only one CP (CP 535) included in the one optical fiber 530.

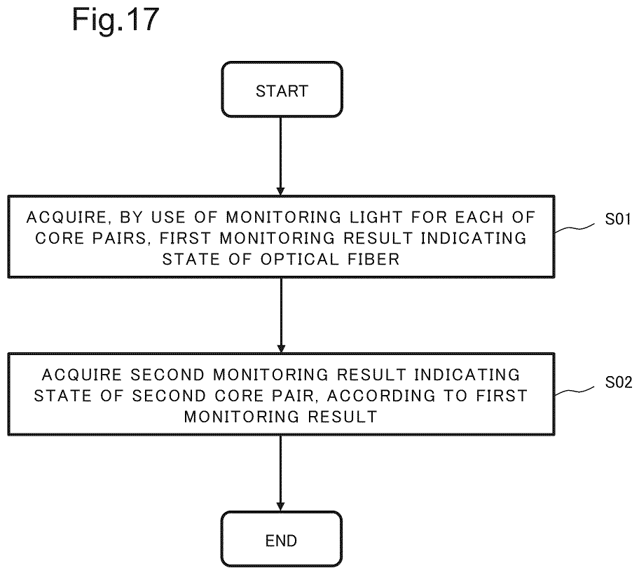

An above-described optical fiber monitoring procedure using the remote monitoring device 300 can also be described as FIG. 17. FIG. 17 is a flowchart illustrating an example of an optical fiber monitoring method. An optical fiber includes a plurality of cores, a pair of cores are designated as a core pair from among the plurality of cores, and a plurality of the core pairs are allocated to the optical fiber. A first monitoring result indicating a state of a first core pair (CP 535 in FIG. 3) included in such an optical fiber is acquired by use of monitoring light (step S01). Then, according to the first monitoring result, a second monitoring result indicating a state of a second core pair (a core pair of another optical fiber) being another core pair is acquired (step S02).

In the first example embodiment and the modified example thereof, when monitoring of one core pair within an optical fiber ends, monitoring of another optical fiber is performed. Thus, a time required for monitoring of a core pair within an optical cable can be shortened.

Note that, in the modified example of the first example embodiment, the core 531 and the core 533 are designated as the CP 535, and the core 532 and the core 534 are designated as the CP 536. When an interval between cores constituting one CP is small, reflected light leaks as crosstalk light to the core in an uplink direction in a part other than the reflector 215 as well, due to crosstalk between the cores. Such crosstalk light becomes noise to reflected light being originally monitored in the remote monitoring device 300. In the present modified example, among the cores 531 to 534, the core 531 and the core 533 having a large distance between cores are designated as the CP 535, and the core 532 and the core 534 are designated as the CP 536, in the optical fiber 530. By selecting a core constituting the CPs 535 and 536 in this way, an influence of crosstalk light on reflected light can be reduced as compared with a case where a CP is constituted by a combination of other cores.

### Second Example Embodiment

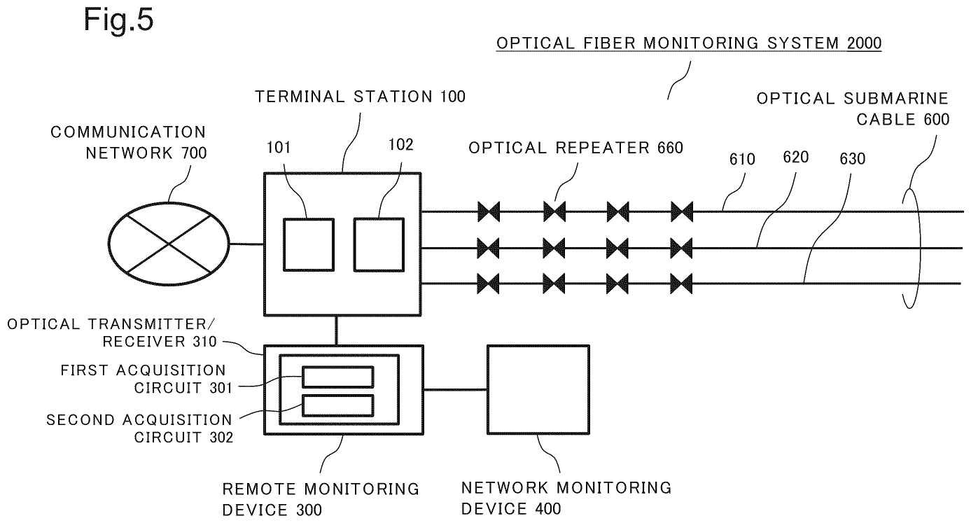

FIG. 5 is a diagram illustrating a configuration example of an optical fiber monitoring system 2000 according to a second example embodiment. The optical fiber monitoring system 2000 includes a terminal station 100, an optical repeater 200, a remote monitoring device 300, a network monitoring device 400, and an optical submarine cable 600.

The terminal station 100 is a land station installed on land, and has an interface function between the optical submarine cable 600 and a communication network 700 on land. The optical interface 101 transmits and receives signal light to and from the optical submarine cable 600. The optical multiplexer/demultiplexer 102 is arranged between the optical interface 101 and the optical submarine cable 600, and multiplexes and demultiplexes monitoring light and signal light. The optical multiplexer/demultiplexer 102 propagates signal light between the optical submarine cable 600 and the optical interface 101, and propagates monitoring light and reflected light between the optical submarine cable 600 and the remote monitoring device 300.

The optical transmitter/receiver 310 included in the remote monitoring device 300 may include a first acquisition circuit 301 and a second acquisition circuit 302. The first acquisition circuit 301 serves as a first acquisition means for acquiring, by use of monitoring light for each of core pairs, a first monitoring result being a monitoring result indicating a state of a first core pair included in a plurality of core pairs allocated to an optical fiber 610. The second acquisition circuit 302 serves as a second acquisition means for acquiring a second monitoring result indicating a state of a second core pair being another core pair, according to the first monitoring result.

The optical submarine cable 600 according to the present example embodiment includes three optical fibers 610, 620, and 630. Each of the optical fibers 610, 620, and 630 is an 8-core MCF. The optical fiber 610 includes cores 611 to 618, and the optical fiber 620 includes cores 621 to 628. The optical fiber 630 includes cores 631 to 638. Each of the optical fibers 610, 620, and 630 includes one or more optical repeaters 660. In the present example embodiment, it is assumed that the configuration of each of the optical repeaters 660 is the same.

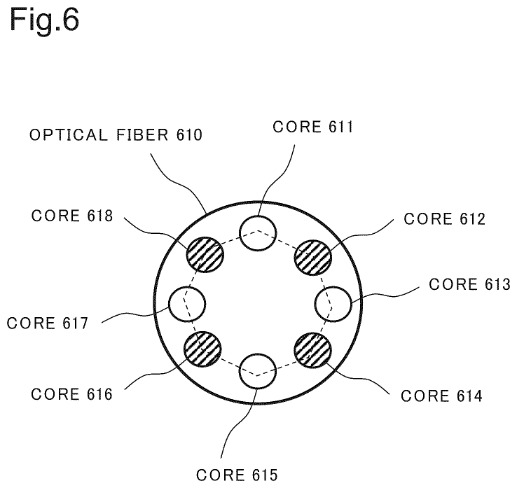

FIG. 6 is a diagram illustrating an example of a cross-section of the optical fiber 610. The cores 611 to 618 are arranged in such a way that positions thereof become eight vertices of one regular octagon. A center of the regular octagon indicated by a broken line in FIG. 6 is located in a center of the cross-section of the optical fiber 610. In other words, the cores 611 to 618 are arranged at an equal interval on a circumference around the center of the cross-section of the optical fiber 610. In FIG. 6, the cores 611 to 618 are arranged in this order at positions going around clockwise the vertices of the regular octagon. Core arrangement and a core number in the optical fibers 620 and 630 are defined in compliance with the optical fiber 610.

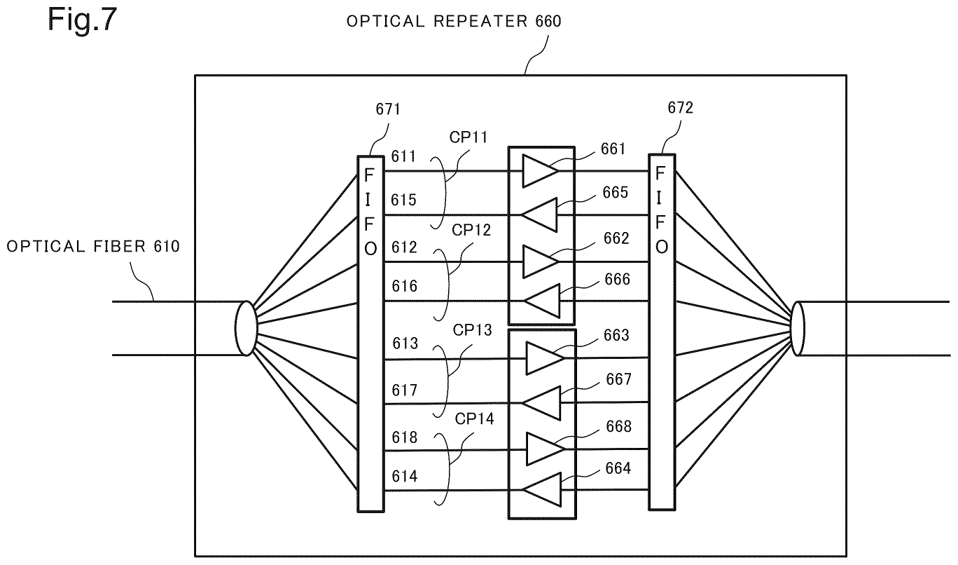

FIG. 7 is a diagram illustrating a configuration example of the optical repeater 660. In FIG. 7, the optical repeater 660 provided in a middle of the optical fiber 610 is described. A configuration of the optical repeater 660 provided in each of the optical fibers 620 and 630 is similar. The optical repeater 660 includes eight optical amplifiers 661 to 668. Each of the optical amplifiers 661 to 668 amplifies light propagating each of the cores 611 to 618. FIFOs 671 and 672 are arranged between two ends of the optical fiber 610 connected to the optical repeater 660 and the optical amplifiers 661 to 668. Each of the FIFOs 671 and 672 connects the cores 611 to 618 of the optical fiber 610 and the optical amplifiers 661 to 668. An MCF connects the optical fiber 610 and one end of the FIFO 671, and the optical fiber 610 and one end of the FIFO 672. An SCF connects one end of each of the optical amplifiers 661 to 668 and another end of the FIFO 671, and another end of each of the optical amplifiers 661 to 668 and another end of the FIFO 672. Each of numbers 611 to 618 between the FIFOs 671 and 672 indicates a number of a core of the optical fiber 610 to which the SCF is connected. In FIG. 7, the cores 611 and 615 are allocated as a CP 11, and the cores 612 and 616 are allocated as a CP 12. Moreover, the cores 613 and 617 are allocated as a CP 13, and the cores 614 and 618 are allocated as a CP 14. Association of a core pair and a core constituting the core pair is similar to those of the CPs 11 to 14 in the CPs 21 to 24 of the optical fiber 620 and the CPs 31 to 34 of the optical fiber 630.

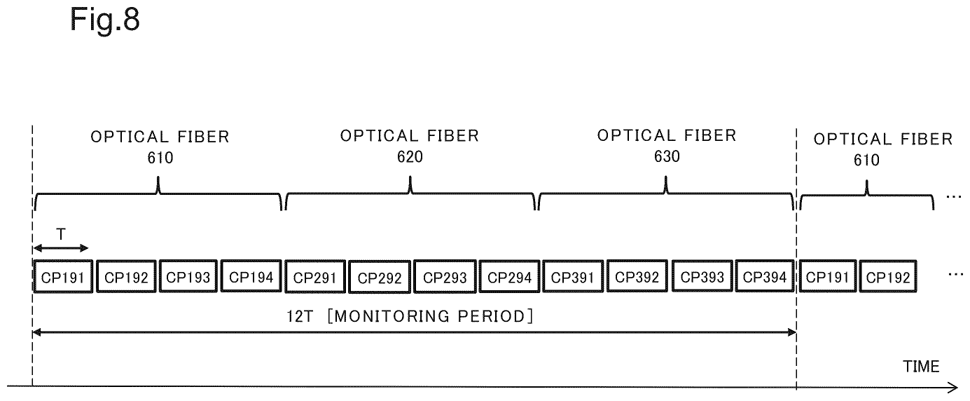

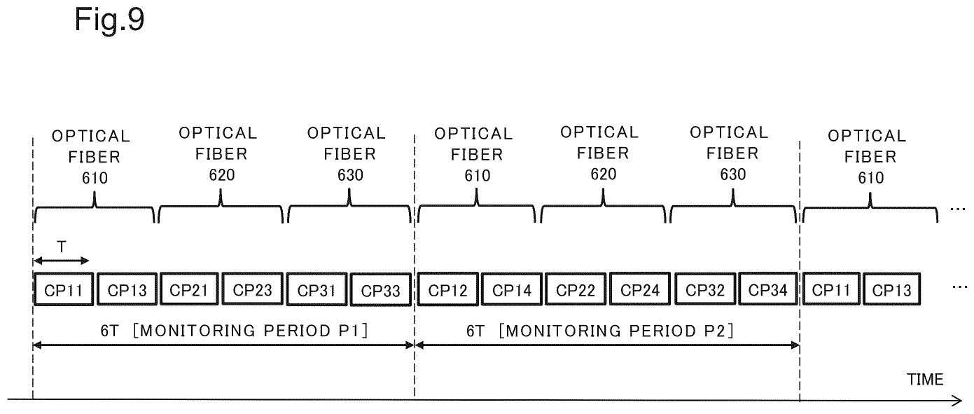

FIGS. 8 and 9 are diagrams describing an example of an order of monitoring the optical fibers 610, 620, and 630 with a time as a horizontal axis. FIG. 8 illustrates a general monitoring procedure, and FIG. 9 illustrates a monitoring procedure according to the present example embodiment. In the general monitoring procedure illustrated in FIG. 8, two adjacent cores are monitored as one core pair. For example, initially, a CP 191 of the optical fiber 610 is monitored. The CP 191 is a core pair made up of the cores 611 and 612. Then, CPs 192, 193, and 194 being remaining core pairs of the optical fiber 610 are monitored. The CP 192 is made up of the cores 613 and 614, the CP 193 is made up of the cores 615 and 616, and the CP 194 is made up of the cores 617 and 618. When monitoring of the CPs 191 to 194 ends, monitoring is performed by a procedure similar to that for the optical fiber 610, regarding core pairs CPs 291 to 294 and CPs 391 to 394 of each of the optical fibers 620 and 630. Note that, it is assumed that, in description of the general procedure in FIG. 8 and the like, an optical amplifier within the optical repeater 660 is arranged in a direction in which monitoring by a core pair used in each procedure is possible.

In the procedure in FIG. 8, in a case where the optical submarine cable 600 includes four or more optical fibers as well, similarly, monitoring of a core pair of another optical fiber is started after monitoring of all core pairs of one optical fiber ends.

When it is assumed that a time T necessary for monitoring one core pair is the same for each core pair, a time required for monitoring of one optical fiber is 4T in FIG. 8. Then, a time necessary for monitoring of the three optical fibers 610, 620, and 630 included in the optical submarine cable 600 is 4×3T=12T. Hereinafter, a period in which monitoring of an optical fiber that has become a monitoring target makes a round in the optical fibers 610, 620, and 630 included in the optical submarine cable 600 may be described as a “monitoring period”. In FIG. 8, a monitoring period is 12T.

FIG. 9 is an example of a monitoring procedure of a core pair according to the present example embodiment. In the procedure in FIG. 9, initially, the CP 11 of the optical fiber 610 is monitored, and the CP 13 is monitored next. Then, when monitoring of the CP 13 ends, monitoring of the optical fiber 620 is executed without performing monitoring of the CPs 12 and 14. By shifting to monitoring of the optical fiber 620 after the CP 13 is monitored following monitoring of the CP 11, a state of an optical amplifier used in each core of the optical fiber 610 can be acquired exhaustively to some degree.

In the optical fiber 620 as well, only the CPs 21 and 23 of the optical fiber 620 are monitored. Then, regarding the optical fiber 630 as well, only the CPs 31 and 33 are monitored. In this way, in the procedure in FIG. 9, when monitoring of two core pairs per optical fiber ends, monitoring of a core pair of another optical fiber is executed. Therefore, in FIG. 9, a monitoring period of the optical submarine cable 600 is 6T. In this way, the procedure in FIG. 9 can monitor all optical fibers in a half time as compared with the procedure in FIG. 8. A reason for this is that, during monitoring of an optical fiber including a plurality of core pairs, another optical fiber is not monitored after monitoring of all core pairs of an optical fiber, but only some core pairs (e.g., CPs 11, 13, 21, 23, 31, and 33) are monitored in one monitoring period. Since such a procedure can shorten a time until shirting to monitoring of another optical fiber, a time required for monitoring of a core pair within an optical cable can be shortened.

Moreover, in the procedure in FIG. 9, the cores 611, 613, 615, and 617 of the optical fiber 610 are used for monitoring. The cores are not adjacent in the optical fiber 610. In this way, by enlarging a distance between cores each included in a plurality of core pairs used for monitoring, a state in a wider region within the cross-section of the optical fiber 610 can be monitored. Further, by enlarging a distance between two cores constituting one core pair, an influence on reflected light resulting from crosstalk light occurring between the cores constituting one core pair can be reduced. For example, in the optical fiber 610, the cores 611 and 615 constitute the CP 11, and, thereby, an influence due to crosstalk light occurring between the cores 611 and 615 can be reduced.

To describe specifically, in the procedure in FIG. 9, monitoring is executed by use of a CP 1 constituted of the cores 611 and 615 in a first monitoring period of the optical fiber 610, and a CP 3 constituted of the cores 613 and 617. In this case, both of the cores 611 and 615 of the CP 1 and the cores 613 and 617 of the CP 3 are not adjacent in the optical fiber 610. Thus, by using the CP 1 and the CP 3, a state in a wider region within the cross-section of the optical fiber 610 can be monitored.

Moreover, each of a distance between the cores 611 and 615 and a distance between the cores 613 and 617 is a maximum distance between cores within the cross-section of the optical fiber 610. Thus, in each of the CP 1 and the CP 3, a monitoring result is not subject to an influence of crosstalk as compared with a case where a core pair with a smaller distance between cores is used. The same also applies to core pairs of the other optical fibers 620 and 630.

In the procedure in FIG. 9, when a first monitoring period P1 having a length of 6T ends, a second monitoring period is started. In a second monitoring period P2, monitoring of the optical fibers 610, 620, and 630 may be executed by use of a core pair that has not been monitored in the monitoring period P1. FIG. 9 illustrates that monitoring using the CPs 12, 14, 22, 24, 32, and 34 is performed in the optical fibers 610, 620, and 630 in the monitoring period P2. In this case, all core pairs are monitored once by monitoring in the period P1 and the period P2. Then, in a case using the CP 12 and the CP 14 in the period P2 as well, an advantage similar to that of monitoring using the CP 11 and the CP 13 can be acquired. Then, in and after a period P3, monitoring using a core pair similar to those in the periods P1 and P2 may be repeated.

### Modified Example of Second Example Embodiment

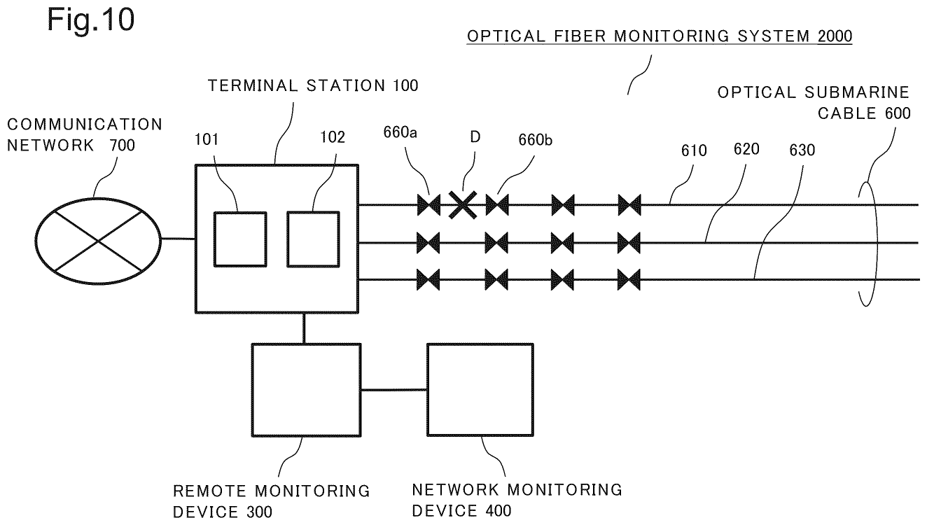

FIG. 10 is a diagram illustrating an example of occurrence of a failure (breaking failure) in which an optical fiber is broken in the optical fiber monitoring system 2000. FIG. 10 illustrates that a breaking failure has occurred at a point D between two optical repeaters 660a and 660b on the optical fiber 610. Each of the optical repeaters 660a and 660b is one example of the optical repeater 660 described earlier. Until occurrence of a breaking failure is detected, the optical fiber monitoring system 2000 monitors the optical fibers 610 to 630 by the procedure described with FIG. 9.

A breaking failure of an optical fiber is sensed at the terminal station 100 by detection of disconnection of signal light and monitoring light, or the like. The terminal station 100 that has sensed a breaking failure notifies the network monitoring device 400 of occurrence of the breaking failure. When receiving the notification that the breaking failure has occurred, the network monitoring device 400 starts monitoring of the optical submarine cable 600 by a relevant procedure.

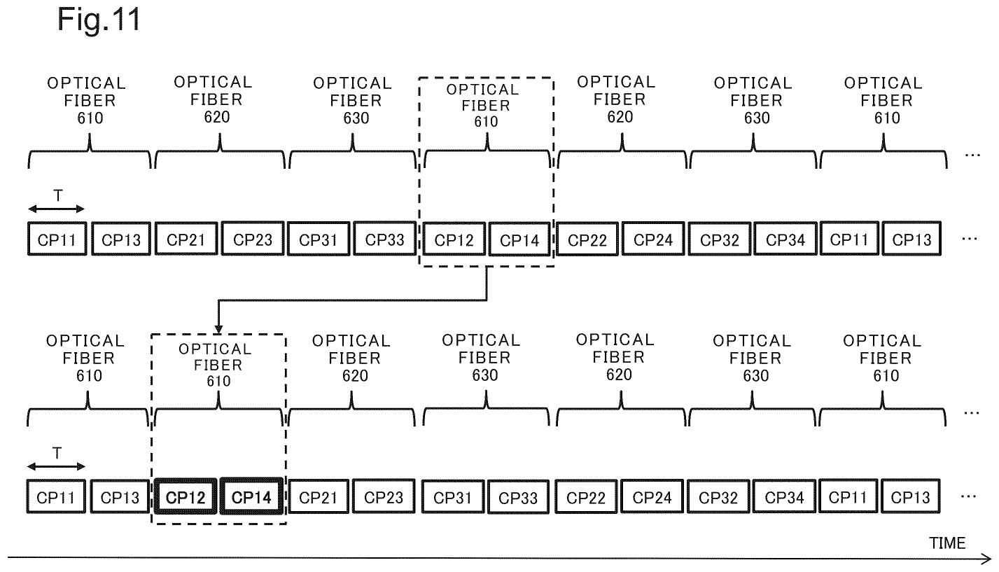

FIG. 11 is a diagram illustrating an example of a monitoring procedure after occurrence of a breaking failure at the point D. FIG. 11 illustrates an example in which monitoring of a core pair of the optical fiber 610 is prioritized over monitoring of the other optical fibers 620 and 630. The procedure in FIG. 9 is illustrated as a reference in an upper part of FIG. 11. A lower part of FIG. 11 illustrates that, when a breaking failure occurs in the optical fiber 610, the CP 12 and the CP 14 of the optical fiber 610 are monitored following monitoring of the CP 11 and the CP 13. In a procedure in the upper part of FIG. 11, monitoring of the CP 12 and the CP 14 is implemented after monitoring of the optical fibers 620 and 630. However, in a procedure in the lower part of FIG. 11, when a breaking failure occurs in the optical fiber 610, monitoring of the CPs 12 and 14 is executed by priority over monitoring of core pairs of the other optical fibers 620 and 630. Due to such a change in a procedure, status of another core in the optical fiber 610 in which a failure has been sensed can be acquired early.

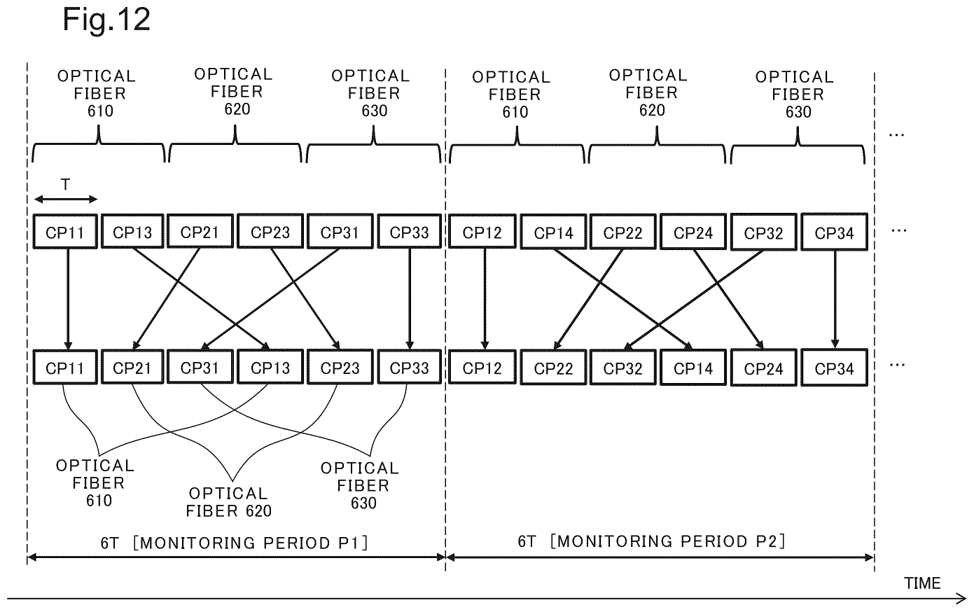

FIG. 12 is a diagram illustrating another example of a monitoring procedure after occurrence of a breaking failure. The procedure in FIG. 9 is illustrated as a reference in an upper part of FIG. 12. A lower part of FIG. 12 illustrates that, when a breaking failure occurs in the optical fiber 610, monitoring of one core pair (the CP 11, the CP 21 and the CP 31) of the optical fibers 610, 620, and 630 is prioritized. In other words, in a procedure in the lower part of FIG. 12, when monitoring of the CP 11 ends in the optical fiber 610 in which a failure has occurred, monitoring of another core pair of the optical fiber 610 is not performed, and only the CP 21 of the optical fiber 620 and the CP 31 of the optical fiber 630 are monitored. After end of monitoring of the CPs 11, 21 and 31, monitoring of the optical fibers 610, 620, and 630 may be similarly performed by use of the CPs 13, 23, and 33. Moreover, a procedure may be similarly changed regarding the CPs 12, 22, and 32 and the CPs 14, 24, and 34.

In this way, the procedure in FIG. 12 prioritizes monitoring of a core pair of another optical fiber over monitoring of another core pair within the same optical fiber. According to the procedure in FIG. 12, presence or absence of a failure of another optical fiber such as the optical fibers 620 and 630 in the optical submarine cable 600 including the optical fiber 610 in which a failure has been sensed can be sensed early.

### Another Modified Example of Second Example Embodiment

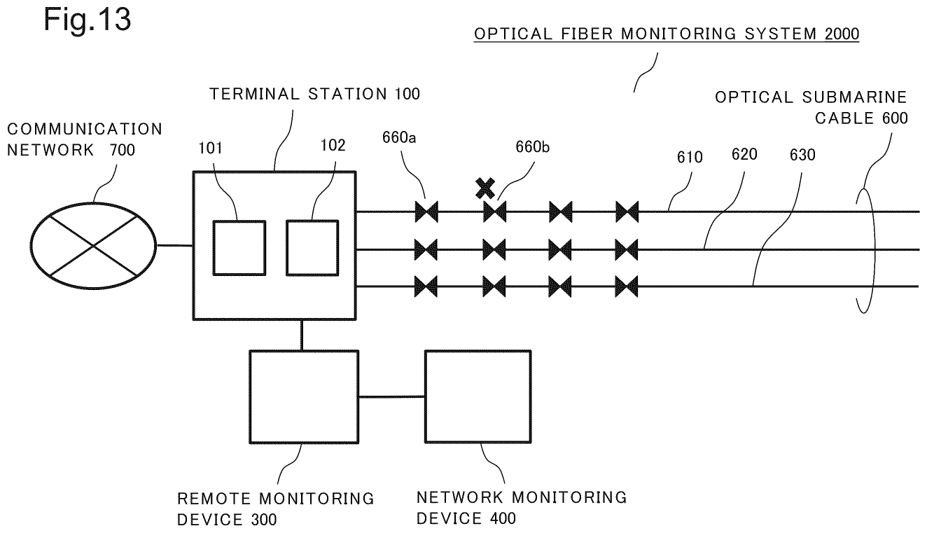

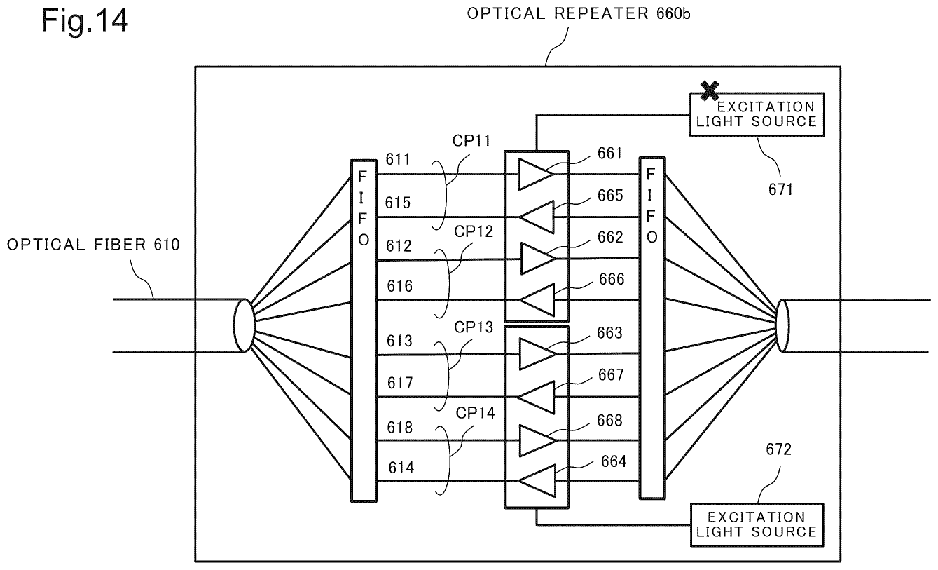

FIG. 13 is a diagram illustrating occurrence of a failure (LD failure) in which an excitation laser diode (LD) of the optical repeater 660a breaks down in the optical fiber monitoring system 2000. The excitation LD is a light emitting element that outputs excitation light. FIG. 14 is a diagram illustrating that an LD failure in the optical amplifier 665 among the eight optical amplifiers 661 to 668 included in the optical repeater 660b on the optical fiber 610 has been sensed. The optical repeater 660b is one example of the optical repeater 660 described earlier. Until occurrence of an LD failure is detected, the optical fiber monitoring system 2000 monitors the optical fibers 610, 620, and 630 by the procedure described with FIG. 9.

In an optical repeater used in an optical transmission system using an MCF or a core pair, a configuration including an excitation light source that couples or decouples excitation light output from a plurality of excitation LDs is known. The excitation light source supplies excitation light to an optical fiber amplifier connected to each of a plurality of core pairs. Such a configuration may be referred to as pump sharing. The pump sharing allows an excitation LD to be redundant, and can improve power efficiency of an optical repeater.

Under such a background, FIG. 14 illustrates an example in which excitation light sources 671 and 672 are included in the optical repeater 660b. The excitation light source 671 decouples and couples excitation light output from a plurality of excitation LDs, and supplies excitation light to the optical amplifiers 661, 665, 662, and 666. The excitation light source 672 decouples and couples excitation light output from a plurality of excitation LDs different from those of the excitation light source 671, and supplies excitation light to the optical amplifiers 663, 667, 664, and 668. In this configuration, the optical amplifiers 661 and 665 connected to the CP 11 and the optical amplifiers 662 and 666 connected to the CP 12 share an excitation LD. Thus, when an LD failure in the optical amplifier 665 is sensed, there is a high possibility that an LD failure also occurs simultaneously in a transmission path including the core 611 or the CP 12. Therefore, when an LD failure in the optical amplifier 665 is sensed, a priority degree of monitoring of another core pair (CP 12) sharing an excitation LD may not be necessarily raised.

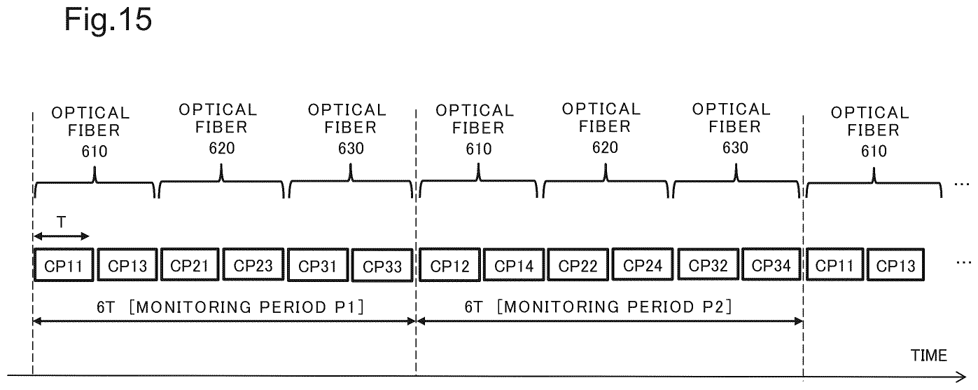

FIG. 15 is a diagram illustrating an example of a monitoring procedure after occurrence of an LD failure. The procedure illustrated in FIG. 15 is similar to that in FIG. 9. As described above, when an LD failure is sensed in the CP 11 of the optical fiber 610, monitoring of the CP 12 of the same optical fiber is not performed after monitoring of the CP 11, the CP 13 of the optical fiber 610 that does not share an excitation LD is monitored, and thereafter, a shift may be made to monitoring of another optical fiber. The CP 11 and the CP 12 share an excitation LD of the excitation light source 671, and the CP 13 and the CP 14 share an excitation LD of the excitation light source 672. Thus, states of the optical amplifiers 661 to 668 may be determined by monitoring of only the CP 11 and the CP 13. FIG. 15 illustrates a procedure that another core pair of the optical fiber 610 including the CP 11 is monitored next when a monitoring result of the CP 11 indicates abnormality.

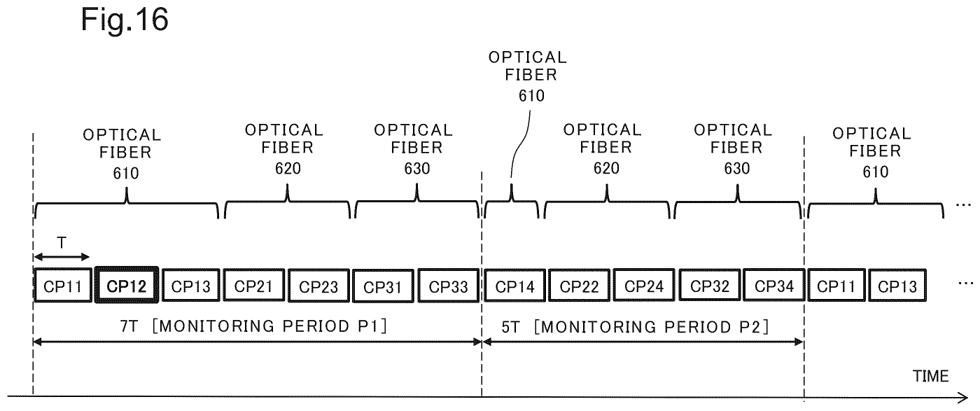

FIG. 16 is a diagram illustrating another example of a monitoring procedure after occurrence of an LD failure. In the procedure in FIG. 16, unlike FIG. 15, monitoring of the CP 11, the CP 12, and the CP 13 is performed in the optical fiber 610 after sensing of an LD failure in the CP 11. The procedure in FIG. 16 performs, by priority, monitoring of another core pair included in the optical fiber 610 in which a failure has been detected, and can confirm status of another core pair of the optical fiber 610 or the whole optical fiber 610 early. In the procedure in FIG. 16, after an LD failure is sensed, a core pair that can be subjected to an influence of the detected failure is monitored by priority in several initial monitoring periods, and thereafter, a return may be made to, for example, a monitoring procedure during normal running illustrated in FIG. 9. Note that, a configuration in a case where an excitation LD is shared has been described in FIG. 15 and FIG. 16. However, the procedure described in FIG. 15 and FIG. 16 may also be applied to a configuration in which a component to be shared is not an excitation LD. Note that, the example embodiments according to the present disclosure can also be described as, but are not limited to, the following supplementary notes.

### Supplementary Note 1

An optical fiber monitoring system including:
an optical fiber including a plurality of cores, in which a pair of cores are designated as a core pair from among the plurality of cores, and to which a plurality of the core pairs are allocated; and
a remote monitoring device that acquires a monitoring result indicating a state of the optical fiber by use of monitoring light for each of the core pairs, wherein
the remote monitoring device
acquires, according to a first monitoring result being the monitoring result of a first core pair included in the plurality of core pairs, a second monitoring result indicating a state of a second core pair being another core pair.

### Supplementary Note 2

The optical fiber monitoring system according to supplementary note 1, wherein
the remote monitoring device includes an optical transmitter/receiver that transmits the monitoring light to one core of a selected core pair, and receives return light of the monitoring light from another core of the selected core pair, and
the monitoring result includes information indicating whether a path through which the monitoring light propagates is normal or abnormal.

### Supplementary Note 3

The optical fiber monitoring system according to supplementary note 2, wherein the monitoring result includes information of at least one of presence or absence of breaking of a path through which the monitoring light and the return light propagate, and a loss.

### Supplementary Note 4

The optical fiber monitoring system according to supplementary note 2 or 3, wherein, when the first monitoring result indicates normality of the path, the remote monitoring device selects the second core pair from another optical fiber not including the first core pair.

### Supplementary Note 5

The optical fiber monitoring system according to any one of supplementary notes 2 to 4, wherein, when the first monitoring result indicates normality of the path, the remote monitoring device selects the second core pair from a core pair in which crosstalk of the monitoring light with the first core pair is smaller.

### Supplementary Note 6

The optical fiber monitoring system according to any one of supplementary notes 2 to 5, wherein, when the first monitoring result indicates abnormality of the path, the remote monitoring device selects the second core pair from another core pair of an optical fiber including the first core pair.

### Supplementary Note 7

The optical fiber monitoring system according to any one of supplementary notes 2 to 5, wherein, when the first monitoring result indicates abnormality of the path, the remote monitoring device selects the second core pair from another optical fiber not including the second core pair.

### Supplementary Note 8

The optical fiber monitoring system according to any one of supplementary notes 2 to 5, wherein, when the first monitoring result indicates abnormality of the path, the remote monitoring device selects the second core pair from another core pair to which a component shared with the first core pair is connected.

### Supplementary Note 9

The optical fiber monitoring system according to supplementary note 8, wherein the first core pair and the second core pair share an excitation light source of an optical amplifier to be used in each of the core pairs.

### Supplementary Note 10

The optical fiber monitoring system according to supplementary note 9, wherein the excitation light source includes a plurality of light emitting elements, decouples and couples excitation light being output from the light emitting element, and supplies the excitation light to the optical amplifier connected to each of a plurality of core pairs.

### Supplementary Note 11

A remote monitoring device including:
a first acquisition means for acquiring a monitoring result indicating a state of an optical fiber including a plurality of cores, in which a pair of cores are designated as a core pair from among the plurality of cores, and to which a plurality of the core pairs are allocated, by use of monitoring light for each of core pairs; and
a second acquisition means for acquiring, according to a first monitoring result being the monitoring result of a first core pair included in the plurality of core pairs, a second monitoring result indicating a state of a second core pair being another core pair.

### Supplementary Note 12

An optical fiber monitoring method including:
acquiring a monitoring result indicating a state of an optical fiber including a plurality of cores, in which a pair of cores are designated as a core pair from among the plurality of cores, and to which a plurality of the core pairs are allocated, by use of monitoring light for each of core pairs; and
acquiring, according to a first monitoring result being the monitoring result of a first core pair included in the plurality of core pairs, a second monitoring result indicating a state of a second core pair being another core pair.

### Supplementary Note 13

The optical fiber monitoring method according to supplementary note 12, further including a procedure of
transmitting the monitoring light to a selected core pair, and
receiving return light of the monitoring light, wherein
the monitoring result includes information indicating whether a path through which the monitoring light propagates is normal or abnormal.

### Supplementary Note 14

The optical fiber monitoring method according to supplementary note 13, wherein the monitoring result includes information of at least one of presence or absence of breaking of a path through which the monitoring light and the return light propagate, and a loss.

### Supplementary Note 15

The optical fiber monitoring method according to supplementary note 13 or 14, further including, when the first monitoring result indicates normality of the path, selecting the second core pair from another optical fiber not including the first core pair.

### Supplementary Note 16

The optical fiber monitoring method according to any one of supplementary notes 13 to 15, further including, when the first monitoring result indicates normality of the path, selecting the second core pair from a core pair in which crosstalk of the monitoring light with the first core pair is smaller.

### Supplementary Note 17

The optical fiber monitoring method according to any one of supplementary notes 13 to 16, further including, when the first monitoring result indicates abnormality of the path, selecting the second core pair from another core pair of an optical fiber including the first core pair.

### Supplementary Note 18

The optical fiber monitoring method according to any one of supplementary notes 13 to 16, further including, when the first monitoring result indicates abnormality of the path, selecting the second core pair from another optical fiber not including the second core pair.

### Supplementary Note 19

The optical fiber monitoring method according to any one of supplementary notes 13 to 16, further including, when the first monitoring result indicates abnormality of the path, selecting the second core pair from another core pair to which a component shared with the first core pair is connected.

While the present disclosure has been described above with reference to example embodiments, the present disclosure is not limited to the example embodiments described above. Various changes that can be understood by a skilled person may be made to a configuration and details according to the present disclosure within the scope of the present disclosure. For example, the optical fiber monitoring system described in each of the example embodiments also discloses an optical fiber monitoring method applicable to the system.

Moreover, the configurations described in the example embodiments are not necessarily exclusive to one another. An action and an effect according to the present disclosure may be achieved by a configuration acquired by combining all or some of the example embodiments described above.

1. An optical fiber monitoring system comprising:
an optical fiber including a plurality of cores, in which a pair of cores are designated as a core pair from among the plurality of cores, and to which a plurality of the core pairs are allocated; and
a remote monitoring device configured to acquire a monitoring result indicating a state of the optical fiber by use of monitoring light for each of the core pairs, wherein
the remote monitoring device
acquires, according to a first monitoring result being the monitoring result of a first core pair included in the plurality of core pairs, a second monitoring result indicating a state of a second core pair being another core pair.

2. The optical fiber monitoring system according to claim 1, wherein
the remote monitoring device includes an optical transmitter/receiver configured to transmit the monitoring light to one core of a selected core pair, and receive return light of the monitoring light from another core of the selected core pair, and
the monitoring result includes information indicating whether a path through which the monitoring light propagates is normal or abnormal.

3. The optical fiber monitoring system according to claim 2, wherein the monitoring result includes information of at least one of presence or absence of breaking of a path through which the monitoring light and the return light propagate, and a loss.

4. The optical fiber monitoring system according to claim 2, wherein, when the first monitoring result indicates normality of the path, the remote monitoring device selects the second core pair from another optical fiber not including the first core pair.

5. The optical fiber monitoring system according to claim 3, wherein, when the first monitoring result indicates normality of the path, the remote monitoring device selects the second core pair from another optical fiber not including the first core pair.

6. The optical fiber monitoring system according to claim 2, wherein, when the first monitoring result indicates normality of the path, the remote monitoring device selects the second core pair from a core pair in which crosstalk of the monitoring light with the first core pair is smaller.

7. The optical fiber monitoring system according to claim 3, wherein, when the first monitoring result indicates normality of the path, the remote monitoring device selects the second core pair from a core pair in which crosstalk of the monitoring light with the first core pair is smaller.

8. The optical fiber monitoring system according to claim 4, wherein, when the first monitoring result indicates normality of the path, the remote monitoring device selects the second core pair from a core pair in which crosstalk of the monitoring light with the first core pair is smaller.

9. The optical fiber monitoring system according to claim 2, wherein, when the first monitoring result indicates abnormality of the path, the remote monitoring device selects the second core pair from another core pair of an optical fiber including the first core pair.

10. The optical fiber monitoring system according to claim 3, wherein, when the first monitoring result indicates abnormality of the path, the remote monitoring device selects the second core pair from another core pair of an optical fiber including the first core pair.

11. The optical fiber monitoring system according to claim 4, wherein, when the first monitoring result indicates abnormality of the path, the remote monitoring device selects the second core pair from another core pair of an optical fiber including the first core pair.

12. The optical fiber monitoring system according to claim 2, wherein, when the first monitoring result indicates abnormality of the path, the remote monitoring device selects the second core pair from another optical fiber not including the second core pair.

13. The optical fiber monitoring system according to claim 3, wherein, when the first monitoring result indicates abnormality of the path, the remote monitoring device selects the second core pair from another optical fiber not including the second core pair.

14. The optical fiber monitoring system according to claim 2, wherein, when the first monitoring result indicates abnormality of the path, the remote monitoring device selects the second core pair from another core pair to which a component shared with the first core pair is connected.

15. The optical fiber monitoring system according to claim 3, wherein, when the first monitoring result indicates abnormality of the path, the remote monitoring device selects the second core pair from another core pair to which a component shared with the first core pair is connected.

16. The optical fiber monitoring system according to claim 14, wherein the first core pair and the second core pair share an excitation light source of an optical amplifier to be used in each of the core pairs.

17. The optical fiber monitoring system according to claim 16, wherein the excitation light source includes a plurality of light emitting elements, decouples and couples excitation light being output from the light emitting element, and supplies the excitation light to the optical amplifier connected to each of a plurality of core pairs.

18. A remote monitoring device comprising:
a first acquisition circuit configured to acquire a monitoring result indicating a state of an optical fiber including a plurality of cores, in which a pair of cores are designated as a core pair from among the plurality of cores, and to which a plurality of the core pairs are allocated, by use of monitoring light for each of the core pairs; and
a second acquisition circuit configured to acquire, according to a first monitoring result being the monitoring result of a first core pair included in the plurality of core pairs, a second monitoring result indicating a state of a second core pair being another core pair.

19. An optical fiber monitoring method comprising:
acquiring a monitoring result indicating a state of an optical fiber including a plurality of cores, in which a pair of cores are designated as a core pair from among the plurality of cores, and to which a plurality of the core pairs are allocated, by use of monitoring light for each of core pairs; and
acquiring, according to a first monitoring result being the monitoring result of a first core pair included in the plurality of core pairs, a second monitoring result indicating a state of a second core pair being another core pair.

20. The optical fiber monitoring method according to claim 19, further comprising a procedure of
transmitting the monitoring light to a selected core pair, and
receiving return light of the monitoring light, wherein
the monitoring result includes information indicating whether a path through which the monitoring light propagates is normal or abnormal.
